(19) United States
(12) Patent Application Publication
(10) Pub. No.: US 2002/0180704 A1
(43) Pub. Date: Dec. 5, 2002

(54) Automatic disabling of computer keyboard insertion point control during typing

(76) Inventor: Michael L. Rudd, Fort Collins, CO (US)

Correspondence Address: HEWLETT-PACKARD COMPANY, Intellectual Property Administration, P.O. Box 272400, Fort Collins, CO, 80527-2400, US

(21) Appl. No.: 09/871,314

(22) Filed: May 30, 2001

(51) Int. Cl. G09G 5/00

(52) U.S. Cl. 345/168

(57) ABSTRACT

A keyboard for a computer includes at least one insertion point control device. When alphanumeric or typographic key on the keyboard are actively being used, the insertion point control device is automatically disabled or ignored for a predetermined period of time. As a result, when a user is actively typing, the insertion point control device is automatically disabled, and when the user pauses, the insertion point control device is re-enabled. Automatically disabling or ignoring the insertion point control device reduces the risk of inadvertent movement of an insertion point.

### FIELD OF INVENTION

This invention relates generally to keyboards used for computers and more specifically to keyboards having a touch-pad or other devices used for control of an insertion point on a display.

### BACKGROUND OF THE INVENTION

Keyboards for computers, and in particular keyboards for laptop computers, commonly have a touchpad and/or cursor control switches for moving the position of a cursor on the display. Moving a finger on the touchpad causes the cursor to move, and pressing or tapping the touchpad moves the point of data entry (the insertion point) to the cursor location. The touchpad and other cursor control switches are commonly located so that when an operator has fingers on the keyboard for typing, the touchpad and cursor control switches are located near the thumbs, for convenient control using the thumbs. If the operator accidentally touches the touchpad during typing, the cursor and insertion point may be moved, so that text or data being typed may suddenly be entered at an unexpected location.

The operator must then delete or move the wrongly located text, and reposition the insertion point. The touchpad and cursor control switches can typically be disabled, through a control menu, so that some other device, for example a mouse, can be used for cursor control. Disabling and enabling through a control menu requires significant time relative to the time required to pause and move the insertion point. There is a need for an automatic way to prevent accidental movement of the insertion point during typing.

### SUMMARY OF THE INVENTION

When alphanumeric or typographic keys on a keyboard are pressed, the touchpad or other devices for insertion point control are automatically disabled or ignored for a predetermined period of time. As a result, when a user is actively typing, the devices for insertion point control are automatically disabled, and when the user pauses, the devices for insertion point control are re-enabled. Automatically disabling the devices for insertion point control reduces the risk of inadvertent movement of the insertion point.

### BRIEF DESCRIPTION OF THE DRAWINGS

FIG. 1 is a block diagram plan view of an example keyboard with a touchpad and cursor control switches.

FIG. 2 is a flow chart of a first example method in accordance with the invention.

FIG. 3 is a flow chart of a second example method in accordance with the invention.

### DETAILED DESCRIPTION OF THE PREFERRED EMBODIMENT OF THE INVENTION

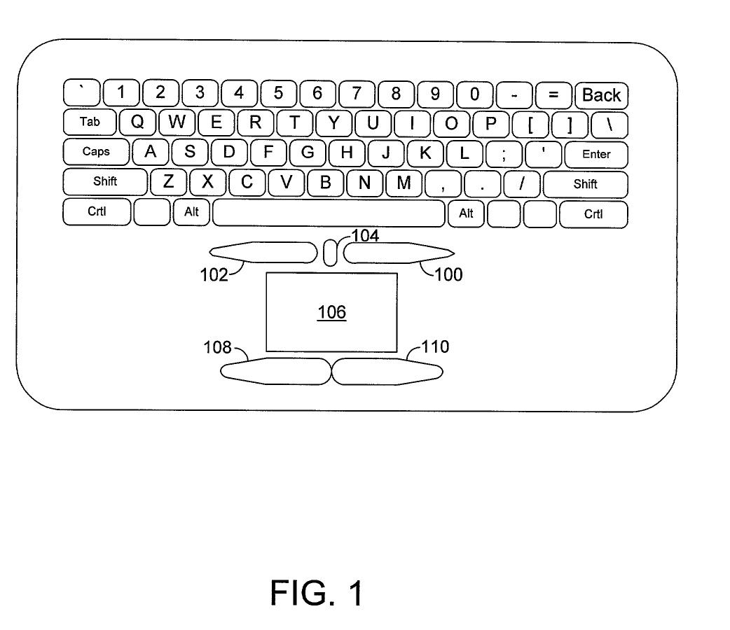

FIG. 1 illustrates an example of a keyboard, typical of keyboards used with laptop computers. The keyboard includes keys for entry of alphanumeric data, including typographic functions such as tab, enter, and backspace, and other functions that affect data entry. In addition to the alphanumeric keys and typographic keys, the keyboard includes cursor control switches (100, 102, 108, and 110), a touchpad 106, and an additional switch 104. The cursor control switches control position of a cursor on a display. Depending on the implementation, the switch 104 may provide the same function as a switch on a mouse, or the same function as a scrolling switch on a mouse. Typically, two cursors are displayed on a screen. The first cursor indicates the insertion point. The second cursor is moved by the cursor control switches, or by the touchpad. If the touchpad is pressed or tapped, deliberately or accidentally, the insertion point moves to the location of the second cursor. When typing, if the thumbs or heels of the hands accidentally touch the touchpad, the second cursor may be moved, and depending on the nature of the touch, the insertion point on the screen may be moved to an unexpected location.

In accordance with an example embodiment of the invention, at least the touchpad is automatically disabled or ignored when the alphanumeric and typographic keys are active. Keyboard activity may comprise, for example, typing at a rate that exceeds a predetermined rate, or pressing keys multiple times within a predetermined time. For example, if any key, other than one of the cursor control devices, is pressed, the touchpad may be disabled immediately for a predetermined time. If any key, other than one of the cursor control devices, is pressed during the predetermined time, then the predetermined time may be re-started. The predetermined period of time may be non-variable, or may be user-controlled. Other switches or cursor controls on the keyboard that cause unwanted results when accidentally touched or pressed may also be disabled or ignored. However, cursor control devices that are not subject to accidental touching while typing, for example a mouse, are preferably left enabled.

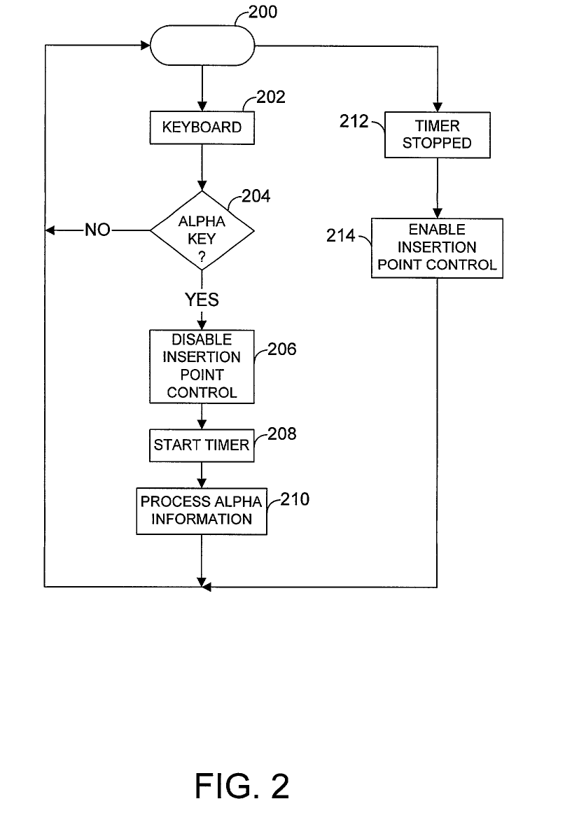

FIG. 2 illustrates an example flow chart for a system in which insertion point movement can be physically disabled (no response generated if an insertion point control device is pressed or tapped while disabled). Step 200 is an interruptible process. At step 202, an interrupt indicates keyboard activity, which may indicate that a key or switch has been pressed, or may indicate that the touchpad or some other cursor control device or insertion point control device is being used. If an alphanumeric or typographical key has been pressed (decision 204), then the insertion point control devices are disabled (step 206), and a timer is started (step 208). At step 210, the system processes the alpha information, for example, by inserting a character at the insertion point. If, at step 204, a cursor insertion point control device was pressed, nothing is disabled and the timer is not started. At step 212, an interrupt indicates that the timer has stopped, and insertion point control is enabled (step 214). Preferably, at step 206, only devices that are subject to accidental touching while typing are disabled, and other devices, for example a mouse, are preferably left enabled.

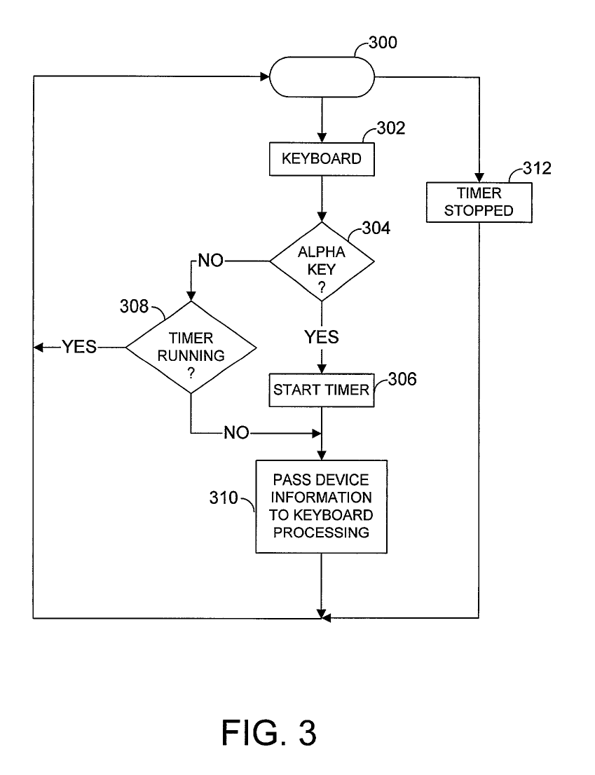

FIG. 3 illustrates an example flow chart for a system in which insertion point control activity is ignored if a timer is running as a result of alphanumeric activity. The process in FIG. 3 intercepts information from the keyboard. Step 300 is an interruptible process. At step 302, an interrupt indicates keyboard activity, which may indicate that a key or switch has been pressed, or may indicate that the touchpad is being used. If an alphanumeric or typographical key has been pressed (decision 304), a timer is started (step 306), and the alphanumeric information is passed on to other software for processing (step 310). If at step 304, an insertion point control device was activated, then at step 308 the program determines whether the timer is running. If the timer is running, the cursor insertion point control activity is ignored. If the timer is not running, the cursor insertion point control information is passed on to keyboard processing software (step 310). At step 312, an interrupt indicates that the timer has stopped. No response is required when the timer stops. Note that additional tests could be made so that only selective insertion point control activity is ignored. For example, at the “NO” path for decision 304, the touchpad could be ignored, and mouse activity could be processed.

Rather than immediately disabling or ignoring cursor control devices when an alphanumeric key is pressed, the system could alternatively wait to detect sustained activity. For example, the cursor control devices could alternatively be disabled or ignored if N alphanumeric keys were pressed during the previous M seconds, where N and M may be non-variable or may be controllable by the operator.

The use of interrupts is used just as an example. The system could alternatively periodically poll the keyboard for activity. In addition, the system could implement a timer in software instead of using a device that interrupts the software.

Note that operating systems commonly provide a user interface that enables an operator to determine how long a key must be depressed before the function is repeated automatically. For example, to fill a line with dots, if the period key is pressed for a user-controllable time, then the display starts to fill with periods. A similar user-interface may be used to set the length of time for a timer used to lock out cursor control, or for a timer used to determine sustained activity.

The foregoing description of the present invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A method for control of a device for insertion point control, comprising:
determining that alphanumeric keys on a keyboard are active; and
disabling the device when the alphanumeric keys are active.

2. The method of claim 1, further comprising:
disabling the device immediately after an alphanumeric key is used.

3. The method of claim 2, further comprising:
disabling the device for a predetermined period of time.

4. The method of claim 1, further comprising:
disabling the device when the alphanumeric keys have been pressed a predetermined number of times during a predetermined time.

5. The method of claim 4, further comprising:
disabling the device for a predetermined period of time.

6. A method for control of a device for insertion point control, comprising:
determining that alphanumeric keys on a keyboard are active; and
ignoring the device when the alphanumeric keys are active.

7. The method of claim 6, further comprising:
ignoring the device immediately after an alphanumeric key is used.

8. The method of claim 7, further comprising:
ignoring the device for a predetermined period of time.

9. The method of claim 6, further comprising:
ignoring the device when the alphanumeric keys have been pressed a predetermined number of times during a predetermined time.

10. The method of claim 9, further comprising:
ignoring the device for a predetermined period of time.

11. A computer, comprising:
a keyboard having alphanumeric keys and at least one device for insertion point control, wherein the device is disabled when the alphanumeric keys are actively being used.

12. The computer of claim 11, further comprising:
the device is disabled immediately after an alphanumeric key is used.

13. The computer of claim 12, further comprising:
the device is disabled for a predetermined period of time.

14. The computer of claim 10, further comprising:
the device is disabled when the alphanumeric keys have been pressed a predetermined number of times during a predetermined time.

15. The computer of claim 14, further comprising:
the device is disabled for a predetermined period of time.

16. A computer comprising:
a keyboard having alphanumeric keys and at least one device for insertion point control, wherein the device is ignored when the alphanumeric keys are actively being used.

17. The computer of claim 16, further comprising:
the device is ignored immediately after an alphanumeric key is used.

18. The computer of claim 17, further comprising:
the device is ignored for a predetermined period of time.

19. The computer of claim 16, further comprising:
the device is ignored when the alphanumeric keys have been pressed a
predetermined number of times during a predetermined time.

20. The computer of claim 19, further comprising:
the device is ignored for a predetermined period of time.
